(19) United States
(12) Patent Application Publication
(10) Pub. No.: US 2006/0076194 A1
(43) Pub. Date: Apr. 13, 2006

(54) Car and car operating panel

(76) Inventor: Masahiko Endo, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/210,852

(22) Filed: Aug. 25, 2005

Related U.S. Application Data
(63) Continuation of application No. PCT/JP04/10438, filed on Jul. 15, 2004.

(30) Foreign Application Priority Data
Aug. 8, 2003 (JP) 2003-290864

(51) Int. Cl. B66B 7/00

(52) U.S. Cl. 187/414

(57) ABSTRACT

A car in an elevator, wherein an inner wall structural member of a car door side of the car is located to be inclined at an angle of 8° to 30° with respect to a line of movement of doors of the car in a direction from a door gate side of the car toward a side plate of a car side portion of the car, and a car-operation panel is attached to the inner wall structural member.

### CROSS-REFERENCE TO RELATED APPLICATIONS

This is a Continuation Application of PCT Application No. PCT/JP2004/010438, filed Jul. 15, 2004, which was published under PCT Article 21(2) in English.

This application is based upon and claims the benefit of priority from prior Japanese Patent Application No. 2003-290864, filed Aug. 8, 2003, the entire contents of which are incorporated herein by reference.

### BACKGROUND OF THE INVENTION

1. Field of the Invention

The present invention relates to a car in an elevator, which is convenient for a passenger or passengers in the elevator.

2. Description of the Related Art

Generally, in an elevator, a rope is wound around a rope pulley connected to a rotation axis of an electric motor, and a car and a counter weight are provided to hang on respective ends of the rope. In such an elevator, an operation control command is issued from an elevator control apparatus in response to a call from a floor or selection of a destination floor by a passenger in the car, and the car and the counterweight are moved in opposite directions, i.e., they are made to ascend/descend by the electric motor, allowing passengers to get on/off the elevator at the destination floor.

In recent years, elevators have been greatly improved with respect to riding comfort and velocity due to the progress of technical development. However, in terms of the interface between the elevators and passengers utilizing them, it is considered that the elevators fail to satisfy a basic point. Actually, no reference regarding the interface between the passenger and the elevator is specifically set. What reference is set is left to manufacturers for manufacturing elevators. Consequently, the elevators have the following problem: for example, when a passenger gets on the car of an elevator other than an elevator with which the passenger is familiar, he or she incorrectly operates a car-operation panel or he or she is at a loss how to use it. Further, the operability and viewability of the car-operation panel are worse. However, since an elevator is used for several minutes only, the car-operation panels have not been tested with respect to usability for passengers, etc.

As stated above, in the car, the car-operation panel is provided in order that a passenger getting on the car operate it to open/close the door of the car or select a destination floor. Of side plates of a door side of the car which are adjacent to right and left doors, side plates of the both sides of the car, and a side plate of an inner rear portion of the car, in general, the car-operation panel is attached to a flat surface portion of the left-hand side plate of the door side, as seen from the front of the car. In such a manner, the car-operation panel attached to the flat surface portion of the side plate of the door side is referred to as a flat type car-operation panel.

However, in such a flat type car-operation panel, a passenger cannot notice or operate operation buttons of the car-operation panel until he or she enters the car and turns through 180°. Thus, it takes a long time until the passenger operates the operation buttons from the time when he or she gets into the car. In addition, when a number of passengers get into the car, they tend to concentrate in the vicinity of the car-operation panel, as a result of which there is a possibility that the car may be crowded or the passengers cannot not operate the operation buttons without delay.

In view of the above, instead of the car having the flat type car-operation panel, some cars have been proposed in which a car-operation panel is attached to a portion inclined with respect to a flatly extending direction of the side plate of the door side of the car.

In a proposed car, when a car-operation panel is attached to a center portion of a side plate on the door side of a car, the car-operation panel is inclined at 10° relative to the surface portion of the side plate of the door side such that a side of the car-operation panel which is close to a door gate side is located backwards toward a side opposite to the surface portion. This technique is disclosed in, e.g., Jpn. Pat. Appln. KOKAI Publication No. 7-232884.

In another proposed car, an inclined wall is provided such that it is inclined at 45° to bridge between a side plate of a door side and a side plate of a side portion of a car, and a car-operation panel is attached to the inclined wall. This technique is disclosed in, e.g., Jpn. Pat. Appln. KOKAI Publication No. 5-270771.

However, with respect to such attachment of a car-operation panel of an elevator as disclosed in Jpn. Pat. Appln. KOKAI Publication No. 7-232884, the following problems are pointed out. First, in the case where the car-operation panel is attached inclined at approximately 8° to the surface portion of the side plate of the door side of a car, if the car is small, and thus the side plates on the door side are narrow, the following problem arises: when a passenger operates the car-operation panel, with the car crowded, or a physically handicapped person operates the car-operation panel, his or her right elbow comes into contact with the side plate of the side portion, since the side plate is close to the side plate on the door side. Consequently, he or she cannot easily operate the car-operation panel.

Second, since the car-operation panel is inclined toward the above opposite side, if a passenger stands close to the right-hand side plate of the door side, as seen from the front of the car, he or she cannot easily view indication of the car-operation panel which indicates, e.g., a stop floor. That is, the viewability is worse.

Third, since the car-operation panel is inclined toward the above opposite side, a passenger getting on the car cannot notice various operation buttons of the car-operation panel until he or she moves inwards to some extent in the car. Accordingly, the viewability is worse, and in addition he or she cannot quickly operate a desired button of the car-operation panel.

On the other hand, in such attachment of a car-operation panel of an elevator as disclosed in Jpn. Pat. Appln. KOKAI Publication No. 5-270771, a passenger getting on the car can relatively easily notice various operation buttons of the car-operation panel; however, there is a blind spot for a passenger standing on a rear side of the car or the passenger cannot easily view indication of the car-operation panel which indicates, e.g., a stop floor.

Therefore, when the case where the car-operation panel is inclined at an angle in the car is considered from the standpoint of a passenger who starts to get on the car and a passenger who has gotten on the car, it has both an advantage and a disadvantage with respect to the operability, viewability and readiness, etc. Such attachment of the car-operation panel is not necessarily optimal. It is therefore important to seek the usability, etc. for a passenger or passengers from an ergonomic standpoint.

### BRIEF SUMMARY OF THE INVENTION

According to an embodiment of the present invention, a car in an elevator, wherein an inner wall structural member of a car door side of the car is located to be inclined at an angle of 8° to 30° with respect to a line of movement of doors of the car in a direction from a door gate side of the car toward a side plate of a car side portion of the car, and a car-operation panel is attached to the inner wall structural member.

According to an embodiment of the present invention, a car in an elevator, wherein an inner wall structural member of a car door side of the car is located to be inclined at an angle of 15° to 30° with respect to a line of movement of doors of the car in a direction from a door gate side of the car toward a side plate of a car side portion of the car, and a car-operation panel is attached to the inner wall structural member.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining the first example of attachment of a car-operation panel in a car of an ordinary elevator.

FIG. 2 is a view for explaining the second example of attachment of a car-operation panel in a car of an ordinary elevator.

FIG. 3 is a view for explaining the third example of attachment of a car-operation panel in a car of an ordinary elevator.

FIG. 4 is an example of an action of a passenger for an example of attachment of the car-operation panel shown in FIG. 1.

FIG. 5 is a side view of a car door side which is obtained as viewed from an inner rear portion of the car in the elevator according to the embodiment of the present invention.

FIG. 6 is a plan view showing a positional relationship between the threshold (movement line of the door) of the car, inner wall structural members of the door side and a car-operation panel in the elevator according to the embodiment of the present invention.

FIG. 7 is a plan view showing in detail attachment of the car-operation panel in the car in the elevator according to the embodiment of the present invention.

FIG. 8 is a view showing an example in which the car-operation panel 19 is attached to a wing wall, which is inclined at 8 to 30°, in the car 1 of the elevator according to the embodiment of the present invention.

FIG. 9 is an example of an action of a passenger for an example of attachment of the car-operation panel shown in FIG. 8.

### DETAILED DESCRIPTION OF THE INVENTION

Before explaining an embodiment of the present invention, the result of a simulation of the set angle of a car-operation panel (also referred to as an operation display panel) and the action of a passenger in a car will be explained as follows:

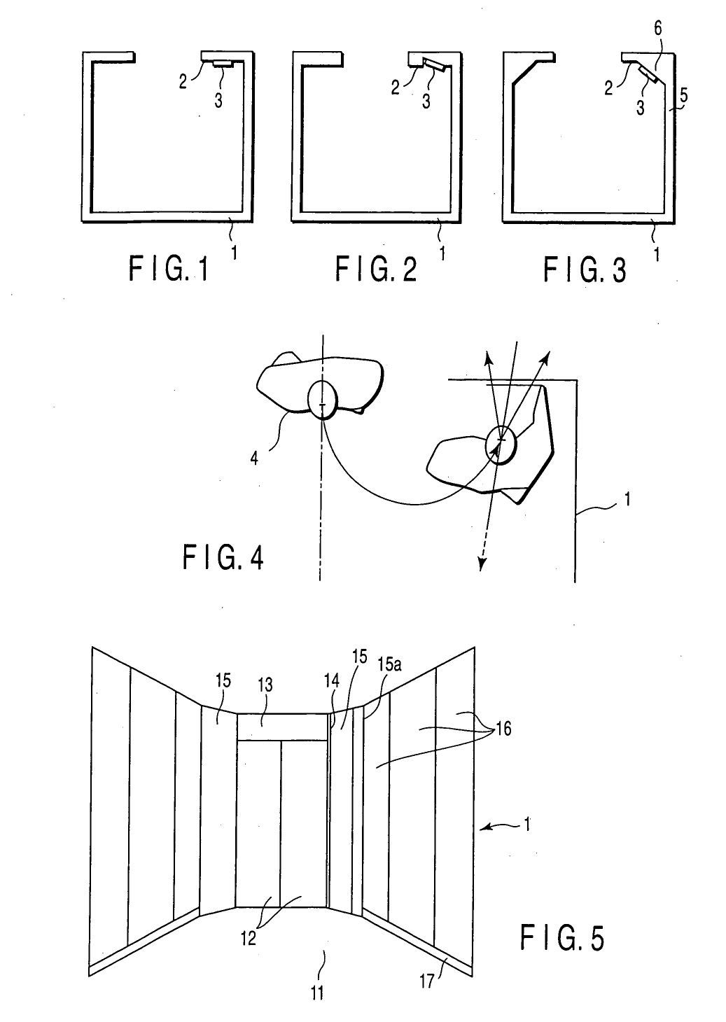

FIG. 1 is a view for explaining the first example of attachment of a car-operation panel in a car of an ordinary elevator.

In the case where the type of a car-operation panel in a car of an elevator is a flat type in which a car-operation panel 3 is attached to a side plate 2 on a door side of a car 1 or a flat surface portion of a wing wall in the car 1 as shown in FIG. 1, a passenger getting on the car 1 cannot easily view various kinds of operation buttons of the car-operation panel 3. As a result, the passenger cannot operate the operation buttons without delay, that is, the operability worsens.

Specifically, when a passenger 4 turns after getting on a car 1, the angle of turn of his or her body axis is great, and the radius of his or her turn is also great as shown in FIG. 4. Inevitably, the track of his or her action is long, and it also takes a long time from the time he or she gets into the car 1 until he or she operates the operation buttons.

When the time required for operating the car-operation panel 3 is long, if a number of passengers get into the car 1 all at once, the time required for operating the elevator is further increased, since the passengers take the same track as the above passenger.

Furthermore, in the case where the type of the car-operation panel 3 of the car 1 is such a flat type as shown in FIG. 1, a passenger cannot completely notice the various kinds of operation buttons of the car-operation panel 3 or press the operation buttons, until he or she completely turn through 180°. Therefore, the above car-operation panel 3 does not have good operability, viewabililty or readiness. Nor is it user-friendly.

On the other hand, in an example shown in FIG. 2, a portion of the surface portion of the side plate 2 of the door side is recessed toward a side opposite to the surface portion such that it is inclined at 10° with respect to the surface portion, and the car-operation panel 3 is attached to the recessed portion of the surface portion of the side plate 2. Thus, the car-operation panel 3 is burrowed with reference to the flat surface portion of the car door-side side plate 2. Actually, assuming that the car-operation panel 3 is attached to be inclined relative to the flat surface portion of the side plate 2, it is merely inclined at approximately 5° at most. Thus, the car-operation panel is not greatly different from the above flat type car-operation panel.

In such a manner, the car-operation panel 3 is located in a position recessed from the flat surface portion of the car door-side side plate 2. Thus, the flat surface portion of the car door-side side plate 2 obstructs the view for a passenger who gets into the car 1. As a result, he or she cannot grasp the operation state of the car-operation panel 3 until he or she turns through approximately 150°.

Furthermore, the position of the car-operation panel 3 is a blind spot for a passenger standing close to a side plate 2 on the door side at the door gate, which is located opposite to the car-operation panel 3, since the flat surface portion of a side plate 2 which is located opposite to the passenger obstructs the view of the passenger. Therefore, the car-operation panel 3 shown in FIG. 2 does not have good operability, viewabililty or readiness. Nor is it user-friendly.

Moreover, in the car 1 shown in FIG. 3, an inclined wall 6 is provided such that it is inclined at 45° to bridge between the side plate 2 of the door side and a side plate 5 of a car side-portion side, and the car-operation panel 3 is attached to the inclined wall 6.

Thereby, the operability, viewability and readiness of the car-operation panel 3 can be improved, as compared with the cars 1 of the types shown in FIGS. 1 and 2. However, it is doubtful whether this is optimal for a passenger or passengers. In such a type of car including a wall inclined at 45°, especially in a large car 1, a passenger standing in the rear of the attachment side of the car-operation panel 3 of the car 1 cannot easily view indication of the car-operation panel 3 which indicates, e.g., a stop floor.

In consideration of such a situation, a simulation was performed with respect to the operability and viewability of the car-operation panel 3 and the readiness of the operation, while varying the angle of inclination of the car-operation panel 3 with respect to the side plate of the door side or the wing wall. As a result, it was found that an optimal result can be obtained when the angle of inclination of the car-operation panel 3 is 24°.

The embodiment of the present invention achieved based on the result of the simulation will be explained with reference to the drawings as follows:

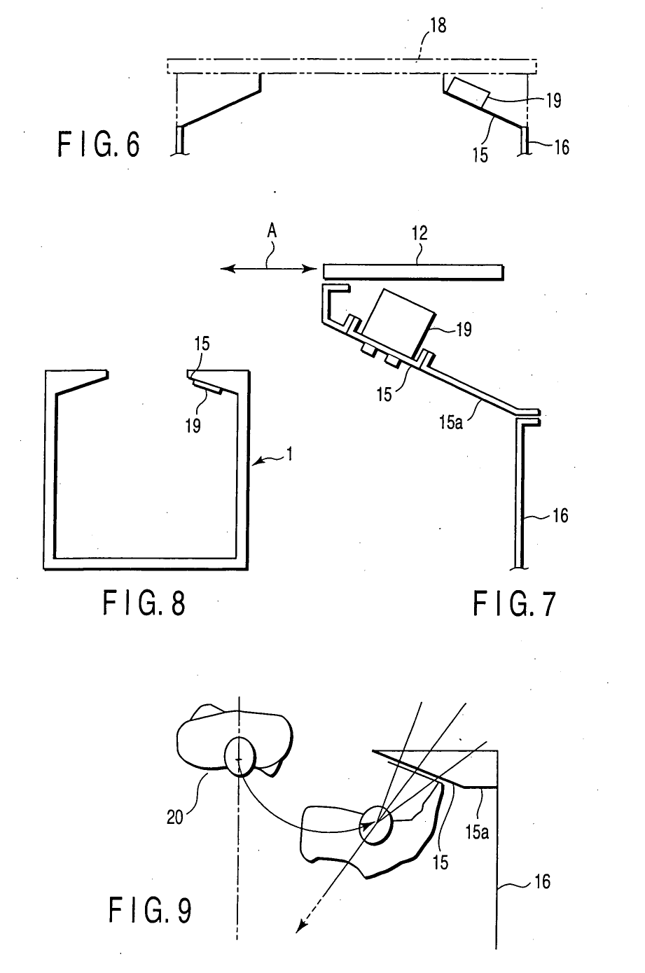

FIGS. 5 to 7 are views for use in explaining an example of the structure of a car in an elevator according to the embodiment of the present invention. FIG. 5 is a side view of a car door side which is obtained as viewed from an inner rear portion of the car in the elevator according to the embodiment of the present invention. FIG. 6 is a plan view showing a positional relationship between the threshold (movement line of the door) of the car, inner wall structural members of the door side and a car-operation panel in the elevator according to the embodiment of the present invention. FIG. 7 is a plan view showing in detail attachment of the car-operation panel in the car in the elevator according to the embodiment of the present invention.

FIG. 5 is a view which shows the inner structure of the car 1 with respect to the door side as viewed from the inner rear portion of the car. The car 1 shown in FIG. 5 comprises a car floor 11, car doors 12, a hanging panel 13, a door post 14, inner wall structural members 15 of its door side, side plates 16 of its both-side portions, plinths 17 and a side plate (not shown) of its inner rear portion, etc.

The car doors 12 are provided upright on left and right sides and movable to a threshold (not shown) of a car front side. The hanging panel 13 fills the space between the tops of the car doors 12 and a ceiling (not shown). The door post 14 is provided on the both sides of the car door or at least the attachment side of the car-operation panel.

The inner wall structural members 15 of the door side are side plates, or wing walls or the like, which extend in respective directions away from the both sides of the car door or the door post 14. The inner wall structural members 15 of the door side are also referred to as return panels. The side plates 16 of the both- side portions are continuous with side end portions of the inner wall structural members 15 of the door side.

As shown in FIGS. 6 and 7, the inner wall structural members 15 of the door side are inclined at an angle of 8 to 30° with respect to a threshold 18 indicated by a chain double-dashed line (see FIG. 6) or a door movement line “A” (see FIG. 7) in a direction from the door side toward the side plates 16. In addition, the inner wall structural members 15 of the door side are directly continuous with the side plates 16 or the inner wall structural members 15 are continuous with the side plates 16, with intermediate side plates 15a therebetween.

A car-operation panel 19 is attached to the inner wall structural member 15 of the door side. To the car-operation panel 19, the same operation buttons as in an ordinary car-operation panel are attached, that is, at least a door opening/closing button and a destination-floor operation button with an indicator light, etc. are attached.

Therefore, the car-operation panel 19 is attached to the inner wall structural member 15 of the door side such that they are inclined at 8 to 30° relative to the car door movement line “A”.

In such a manner, the inner wall structural member 15 of the door side is inclined at 8 to 30°. This is intended to further improve the operability, viewability and readiness, etc., as compared with the set angle of a conventional car-operation panel, based on the result of the above simulation. It will be explained in detailed with reference to FIGS. 8 and 9.

FIG. 8 is a view showing an example in which the car-operation panel 19 is attached to a wing wall, which is inclined at 8 to 30°, in the car 1 of the elevator according to the embodiment of the present invention. FIG. 9 is an example of an action of a passenger for an example of attachment of the car-operation panel shown in FIG. 8.

When the car-operation panel 19 is attached in the manner shown in FIG. 8, the angle at which a passenger 20 getting on the car 1 turns is small, as a result of which the track of the action of the passenger 20 from the time he or she gets into the car 1 to the time he or she notices the car-operation panel 19 is short, and thus he or she can shortly recognize the operation state of the car-operation panel 19 after getting on the car 1. Furthermore, since the angle of turn of the passenger is small, the destination floor selection operation button of the car-operation panel 10 is not pushed, the passenger 20 can immediately operate the operation button of the car-operation panel 19 simply by stretching his or her hand.

In addition, when a number of passengers get into the car 1, they can successively smoothly do so. This is because the track of a passenger's action from the time he or she gets into the car 1 to the time he or she notices the car-operation panel 19 is short. Also, when a lot of passengers get into the car all at once, they can smoothly do.

Moreover, since the car-operation panel 19, as stated above, is inclined at 30° or more, there is no case where a passenger standing on the rear side in the car 1 cannot easily view the car-operation panel 19. That is, the viewability of the car-operation panel 19 for a passenger or passengers standing on the rear side in the car 1 can be improved.

Similarly, there is no case where a passenger standing, on the door side, on a side opposite to the car-operation panel 19 cannot easily view the car-operation panel 19. That is, the operability, viewability and readiness, etc. can be improved, as compared with a car-operation panel inclined at the conventional set angle.

Also, the car-operation panel 19 is inclined at, preferably, 15 to 30° in the direction from the door gate side toward the side plate, the viewability of the car-operation panel 19 can be further improved. According to the results of various simulations, when the car-operation panel 19 was inclined at 24°, the best result was obtained with respect to the usability for persons, which includes the operability, viewability and readiness, etc.

Furthermore, as shown in FIG. 7, when the car-operation panel 19 is provided closer to the door of the car than the side plate serving as the inner wall structural member 15 of the door side or the center line of the wing wall, the angle at which the passenger getting on the car 1 turns to operate the car-operation panel 19 is further decreased, and the track of his or her action from the time he or she gets into the car 1 to the time he or she operates the car-operation panel 19 is shortened, the operability and readiness of the car-operation panel 19 are improved. In addition, within the range of angles 8° to 30°, the smaller the angle, the higher the viewability.

The present invention is not limited to the above embodiment, and can be modified without departing from its subject matter, and be put to practical use. For example, characters, etc. are added to the surfaces of the operation buttons attached to the car-operation panel. The characters may be provided such that they are projected or they are not projected. Also, they may be provided as Braille points in consideration of a visually impaired person. Furthermore, in the car-operation panel, a display device such as a liquid display which can display or input various information can be provided. In addition, the conventional car-operation panel can be easily replaced by the car-operation panel of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A car in an elevator, wherein an inner wall structural member of a car door side of the car is located to be inclined at an angle of 8° to 30° with respect to a line of movement of doors of the car in a direction from a door gate side of the car toward a side plate of a car side portion of the car, and a car-operation panel is attached to the inner wall structural member.

2. The car in the elevator, according to claim 1, wherein the inner wall structural member is a side plate of both side portions of the door side, and the car-operation panel is attached to one of side plates of the both side portions.

3. The car in the elevator, according to claim 1, wherein the inner wall structural member is a wing wall of both side portions of the door side, and the car-operation panel is attached to one of wing walls of the both side portions.

4. The car in the elevator, according to claim 1, wherein the car-operation panel is attached to the inner wall structural member to make a position of a surface of the car-operation panel coincide with that of a surface of the inner wall structural member.

5. The car in the elevator, according to claim 2, wherein the car-operation panel is attached to the inner wall structural member to make a position of a surface of the car-operation panel coincide with that of a surface of the inner wall structural member.

6. The car in the elevator, according to claim 3, wherein the car-operation panel is attached to the inner wall structural member to make a position of a surface of the car-operation panel coincide with that of a surface of the inner wall structural member.

7. The car in the elevator, according to claim 1, wherein the car-operation panel is displaced from a center line of the inner wall structural member in a direction toward the door side.

8. The car in the elevator, according to claim 2, wherein the car-operation panel is displaced from a center line of the inner wall structural member in a direction toward the door side.

9. The car in the elevator, according to claim 3, wherein the car-operation panel is displaced from a center line of the inner wall structural member in a direction toward the door side.

10. A car in an elevator, wherein an inner wall structural member of a car door side of the car is located to be inclined at an angle of 15° to 30° with respect to a line of movement of doors of the car in a direction from a door gate side of the car toward a side plate of a car side portion of the car, and a car-operation panel is attached to the inner wall structural member.
